(19) United States
(12) Patent Application Publication
(10) Pub. No.: US 2009/0278887 A1
(43) Pub. Date: Nov. 12, 2009

(54) INK-JET PRINTER AND MAINTENANCE METHOD OF INK-JET HEAD THEREOF

(75) Inventor: Tadashi IWASAKI, Hachioji-shi (JP)

Correspondence Address: Frishauf, Holtz Goodman & Chick, P.C., 220 Fifth Avenue - 16th Floor, New York, NY, 10001-7708, US

(73) Assignee: Olympus Corporation, Tokyo (JP)

(21) Appl. No.: 12/433,988

(22) Filed: May 1, 2009

(30) Foreign Application Priority Data
May 9, 2008 (JP) 2008-124004

(51) Int. Cl. B41J 2/165

(52) U.S. Cl. 347/33

(57) ABSTRACT

An ink-jet printer of the present invention includes an ink-jet head provided with nozzles for ejecting ink, a downstream tank communicating with the ink-jet head, a pressure pump for producing pressure in the downstream tank to eject ink from the nozzles in a purge operation, a sweep member provided in a maintenance unit, for sweeping away ink and foreign matter remaining around the nozzles after the purge operation, and a control device for keeping the nozzles at a slight positive pressure at the time of ink sweep. Further, the control device produces the slight positive pressure after opening the downstream tank to the atmosphere.

### CROSS-REFERENCE TO RELATED APPLICATIONS

This application is based upon and claims the benefit of priority from prior Japanese Patent Application No. 2008-124004, filed May 9, 2008, the entire contents of which are incorporated herein by reference.

### BACKGROUND OF THE INVENTION

1. Field of the Invention

The present invention relates to an ink-jet printer which includes nozzles for ejecting ink, and in which each nozzle is kept at a slight positive pressure, and a maintenance method of an ink-jet head thereof.

2. Description of the Related Art

In an ink-jet printer, in an ink-jet head for ejecting ink from nozzles, the inside of the ink-jet head is kept at slightly negative pressure, an ink meniscus is formed in each nozzle, and a predetermined pressure wave is produced in a pressure chamber, whereby ink is ejected from the nozzles. Accordingly, forming a meniscus in a nozzle is important in maintaining the ejection characteristics of the ink-jet head.

In an ink-jet head, the meniscus is often broken because of adhesion of foreign matter to the nozzle, ingress of an air bubble, or similar problems. In such a case, in order to restore the meniscus, an operation called maintenance is carried out. That is, the foreign matter or the air bubble is removed by carrying out an operation of applying positive pressure to the pressure chamber to force the ink from the chamber through the nozzle, this being called a purge operation. After that, an operation of wiping off the ink and foreign matter remaining on the nozzle surface is carried out, this being called a wiping operation. As a result of this, the meniscus is restored.

In, for example, Jpn. Pat. Appln. KOKAI Publication No. 2005-231358, a technique is disclosed in which a wiping operation is carried out in a state where the pressure chamber is kept at a low positive pressure, called slight positive pressure, to such a degree that ink does not substantially escape from the nozzle. This prevents air from being forced into the nozzle by the wiping operation or prevents the foreign matter already discharged from the nozzle from being drawn into the nozzle again by the wiping operation.

### BRIEF SUMMARY OF THE INVENTION

Accordingly, an object of the present invention is to provide a maintenance method of an ink-jet head by which slight positive pressure exhibiting reduced variation can be produced at the time of a wiping operation.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing the configuration of an ink-jet printer 10 which is an image formation apparatus according to a first embodiment of the present invention.

FIGS. 2A to 2D are views for explaining a maintenance operation of the ink-jet printer of the first embodiment of the present invention.

FIG. 3A is a timing chart for explaining variation with time of gage pressure of a nozzle of an ink-jet head 50 during the maintenance operation, and FIGS. 3B to 3E are timing charts for explaining operation of each of a solenoid valve 22, a solenoid valve 32, a pressure pump 42, and a sweep member 66, all of which are associated with the maintenance operation.

FIG. 4 is a block diagram showing the configuration of an ink-jet printer 10a which is an image formation apparatus according to a modification example of the first embodiment of the present invention.

FIGS. 5A to 5D are views for explaining a maintenance operation of the ink-jet printer of the modification example of the first embodiment of the present invention.

FIG. 6A is a timing chart for explaining variation with time of gage pressure of a nozzle of an ink-jet head 50 during the maintenance operation, and FIGS. 6B to 6F are timing charts for explaining operation of each of a solenoid valve 22, a solenoid valve 32, a solenoid valve 82, a suction pump 84, and a sweep member 66, all of which are associated with the maintenance operation.

FIG. 7 is a block diagram showing the configuration of an ink-jet printer 10b which is an image formation apparatus according to a second embodiment of the present invention.

FIGS. 8A and 8B are views for explaining a maintenance operation of the ink-jet printer of the second embodiment of the present invention.

FIG. 9A is a timing chart for explaining variation with time of gage pressure of a nozzle of an ink-jet head 50 during the maintenance operation, and FIGS. 9B to 9E are timing charts for explaining a stopper position of a piston 92, and operation of each of a solenoid valve 32, a pressure pump 42, and a sweep member 66, all of which are associated with the maintenance operation.

### DETAILED DESCRIPTION OF THE INVENTION

Embodiments of the present invention will be described below with reference to the accompanying drawings.

### First Embodiment

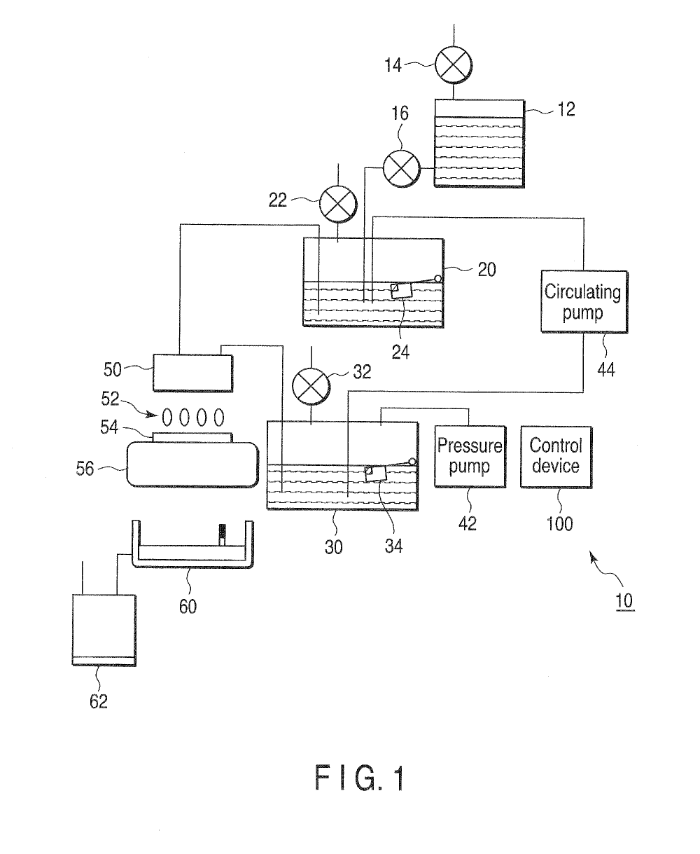

FIG. 1 is a block diagram showing the configuration of an ink-jet printer 10 which is an image formation apparatus according to a first embodiment of the present invention.

In FIG. 1, the ink-jet printer 10 is configured to include a main ink tank 12, solenoid valves 14, 16, 22, and 32, upstream tank 20, downstream tank 30, pressure pump 42, circulating pump 44, ink-jet head 50, recording medium conveyance section 56, maintenance unit 60, waste ink tank 62, and control device 100.

The main ink tank 12 is used to contain liquid ink, and communicates with the upstream tank 20 which is a pressurization section through an ink tube. Solenoid valve 14 is a valve for controlling the state of the main ink tank 12 where the tank 12 is opened to the atmosphere. Solenoid valve 16 is a valve for controlling the state where the main ink tank 12 and upstream tank 20 communicate with each other.

The upstream tank 20 is connected to the ink-jet head 50 which is a recording head, and the circulating pump 44 through ink tubes. Further, the upstream tank 20 is positioned vertically above the downstream tank 30 which is a pressurization section. Solenoid valve 22 is a valve for controlling the state of the upstream tank 20 where the tank 20 is opened to the atmosphere.

The ink-jet head 50 is connected to the upstream tank 20 and downstream tank 30 through ink tubes. Further, the ink-jet head 50 is positioned vertically below the upstream tank 20, and vertically above the downstream tank 30. Further, the ink-jet head 50 ejects ink drops 52 of a predetermined amount toward a recording medium 54 to which the head 50 is opposed at a predetermined timing.

The recording medium conveyance section 56 which is a medium conveyance means conveys the recording medium 54 in a predetermined direction to be linked with the operation of the ink-jet head 50.

The downstream tank 30 is connected to the ink-jet head 50, and circulating pump 44 through ink tubes, and is positioned vertically below the upstream tank 20. Further, solenoid valve 32 is a valve for controlling the state of the downstream tank 30 where the tank 30 is opened to the atmosphere.

The circulating pump 44 is connected to the downstream tank 30 and upstream tank 20 through ink tubes, and pumps up ink from the downstream tank 30 to the upstream tank 20.

As described above, the upstream tank 20, ink-jet head 50, downstream tank 30, and circulating pump 44 constitute a circulation path through ink tubes. When an image formation operation is carried out, the ink is circulated through this circulation path.

The upstream tank 20 and downstream tank 30 are provided with an upstream tank ink level sensor 24 for detecting the ink level of the upstream tank 20, and downstream tank ink level sensor 34 for detecting the ink level of the downstream tank 30, respectively.

Further, the pressure pump 42 serving as a purge means is connected to the downstream tank 30, and the circulation path described previously can be pressurized by feeding the outside air into the downstream tank 30.

The control device 100 receives signals from all the sensors of the ink-jet printer 10 including the upstream tank ink level sensor 24 and downstream tank ink level sensor 34. Further, the control device 100 carries out drive-control of all the drive parts of the ink-jet printer 10 including the ink-jet head 50, medium conveyance section 56, solenoid valves 14, 16, 22, and 32, pressure pump 42, and circulating pump 44 on the basis of the received signals.

The maintenance unit 60 is a device for carrying out the maintenance of the ink-jet head 50. The maintenance unit 60 is in the standby position below the medium conveyance section 56 at the time of non-maintenance. At the time of maintenance, the maintenance unit 60 and medium conveyance section 56 are moved by a transportation means (not shown). As a result of this, the maintenance unit 60 is moved to a position between the ink-jet head 50 and medium conveyance section 56, and the maintenance operation is carried out.

It should be noted that the waste ink tank 62 is connected to the maintenance unit 60. Waste ink produced by the maintenance operation flows down from the maintenance unit 60, and is kept in the waste ink tank 62.

Next, the operation of each part to be carried out at the time of ink circulation will be described below.

At the time of the circulation operation, solenoid valve 22 is in the opened state, solenoid valve 32 is in the closed state, the upstream tank 20 is opened to the atmosphere, and the downstream tank 30 is tightly closed. When the circulating pump 44 is driven in this state, ink is fed from the downstream tank 30 to the upstream tank 20. The downstream tank 30 is tightly closed, and hence the pressure inside the tank 30 becomes negative. As a result, ink flows from the upstream tank 20 to the downstream tank 30 through the ink-jet head 50. At this time, the circulating pump 44 is controlled in such a manner that the ink-jet head 50 is subjected to predetermined negative pressure suitable for image formation. The image formation operation is carried out at the time of ink circulation.

It should be noted that, in the present invention, the terms positive pressure and negative pressure always imply gage pressure which represents a pressure difference from atmospheric pressure.

At the time of non-circulation of ink, solenoid valve 22 is in the closed state, solenoid valve 32 is in the opened state, and the circulating pump 44 is stopped. As a result of this, the ink-jet head pressure 50 becomes negative. At the time of standby at which no image formation operation is carried out, at the time of power-off, or the like, the state is that of non-circulation of ink.

As described above, both at the time of ink circulation and standby, the ink-jet head is negative in pressure. Accordingly, a concave meniscus is formed in the nozzle (not shown) of the ink-jet head 50. Even when the ink-jet head 50 has a slight positive pressure, for example, about 1 kPa or less, due to the surface tension of the meniscus, the ink never escapes from the nozzle. When the positive pressure of the head 50 exceeds the above value, the meniscus is broken, and the ink escapes from the nozzle. Likewise, slight negative pressure implies a pressure at which the outside air is never drawn into the nozzle even when the negative pressure is as small as, for example, about −1 kPa or less.

Further, it is determined by a predetermined algorithm on the basis of output signals from the upstream tank ink level sensor 24 and downstream tank ink level sensor 34 that the amount of ink inside the circulation path has become a predetermined amount or less because of the image formation operation of the ink-jet head 50. Then, both solenoid valves 14 and 16 are brought into the opened state, and ink is supplied from the main ink tank 12 to the upstream tank 20. As a result of this, the amount of ink in the ink circulation path is kept appropriate at all times.

Next, the maintenance operation will be described below.

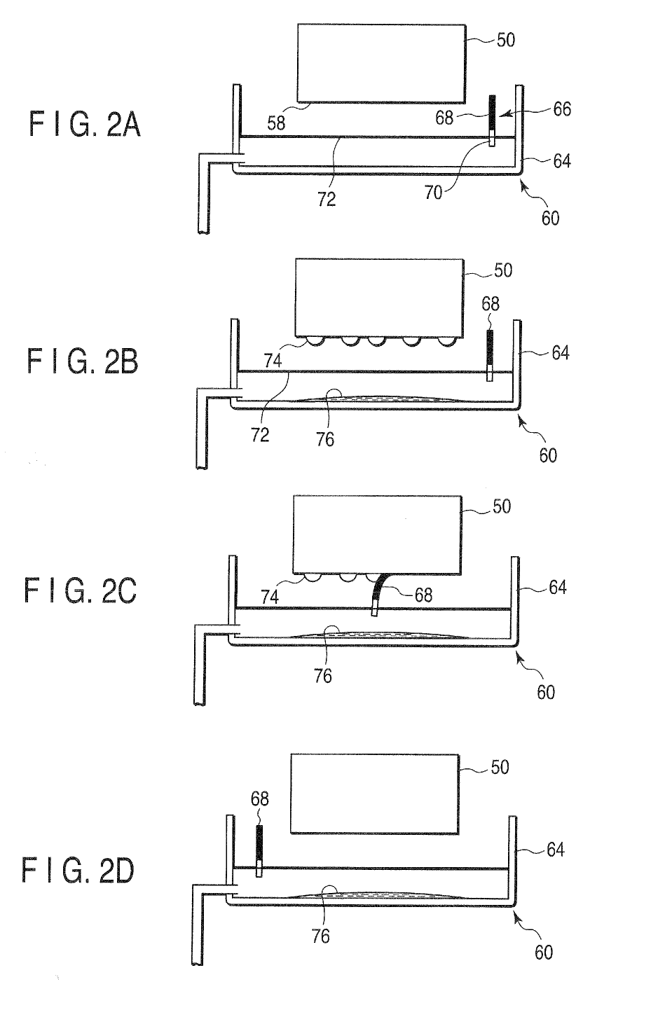

FIG. 2A is a view showing the configuration of the ink-jet head 50 and the vicinity thereof at the time of starting of the maintenance.

When the maintenance is to be started, the ink-jet head 50 is covered with an ink pan 64, and the maintenance waste ink is prevented from being scattered. The sweep member 66 which is a sweeping means is constituted of a blade 68 for sweeping off the nozzle surface 58, and a support member 70 for supporting the blade 68.

The hardness of the blade 68 is of such a degree that the nozzle surface 58 is not scratched, the blade being constituted of, for example, Viton, Teflon (registered trade name) or the like. Further, the height of the blade 68 is adjusted in such a manner that the upper end thereof is higher than the nozzle surface 58 by, for example, about 1 mm. As the support member 70, one made of a material having rigidity to a certain degree such as metal or plastic is suitable. The support member 70 is fitted on a rail 72. The sweep member 66 is conveyed in the arrangement direction of the nozzles 58 along the rail 72 by the conveyance means (not shown). The circulating pump 44 does not operate during the maintenance operation.

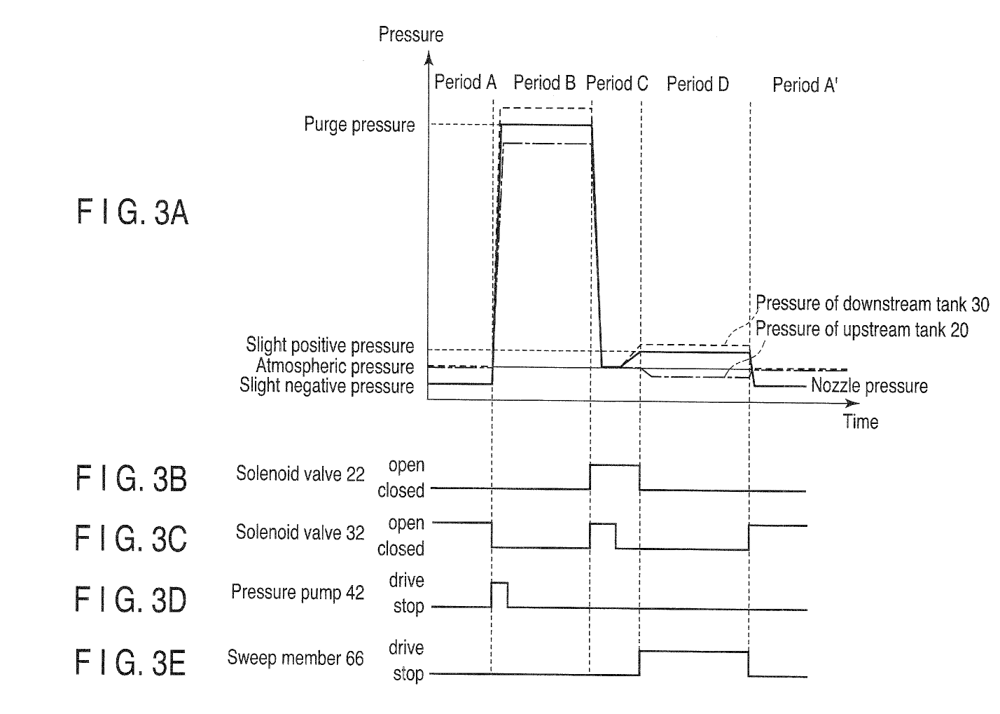

Next, details of the maintenance operation, which is the characteristic aspect of this embodiment, will be described below with reference to FIGS. 2A to 2D and 3A to 3E.

FIGS. 2A to 2D are views for explaining the maintenance operation. FIG. 3A is a timing chart for explaining variation with time of gage pressure of a nozzle of an ink-jet head 50 during the maintenance operation, and FIGS. 3B to 3E are timing charts for explaining operation of each of solenoid valve 22, solenoid valve 32, the pressure pump 42, and the sweep member 66, all of which are associated with the maintenance operation.

The maintenance operation is started by inputting a maintenance command by a user when a white line is seen on the recording medium 54 or is started at the time of automatic maintenance to be carried out when printing of a predetermined number of sheets has been carried out. The maintenance command is input by means of a keyboard (not shown), pointing device (mouse) (not shown) or the like, and the control device 100 starts the operation on the basis of this input.

When the maintenance operation is started (see period A of FIG. 3A), the circulating pump 44 is stopped, and the medium conveyance section 56 is moved from a printing position to a predetermined retraction position. Further, the maintenance unit 60 is moved to a position opposed to the nozzle surface 58, and the positional relationship shown in FIG. 2A is obtained.

Next, a purge operation is carried out (see period B of FIG. 3A). In the purge operation, first, solenoid valves 22 and 32 are closed, and then the upstream tank 20 is pressurized by the pressure pump 42 through the downstream tank 30 and ink path. At this time, the gage pressure of the ink-jet head 50 is, for example, 20 kPa. Accordingly, as shown in FIG. 2B, ink drops 74 are discharged from the nozzles to drop (ink 76) onto the ink pan 64, and some of the ink remains on the nozzle surface 58 as drops (ink drops 74).

Further, after a predetermined time has elapsed 5 (see period C of FIG. 3A), solenoid valves 22 and 32 are opened, and the upstream tank 20 and downstream tank 30 are returned to atmospheric pressure. After this, when solenoid valves 22 and 32 are closed again with a predetermined timing difference, the nozzle pressure becomes slightly positive. In this embodiment, the term nozzle pressure implies the gage pressure of the ink in the vicinity of the nozzles of the ink-jet head 50 or the gage pressure of the meniscus.

The predetermined timing difference is dependent on the vertical relative positional relationship between the nozzle surface 58, the ink level of the upstream tank 20, and the ink level of the downstream tank 30. More specifically, the above is as follows. It is assumed that a height greater than an intermediate height between the ink level of the upstream tank 20 and the ink level of the downstream tank 30 by a predetermined amount or greater, and closer to the upstream tank 20 is H. Further, if the nozzle surface 58 is higher than height H, and is closer to the upstream tank 20, solenoid valve 32 is closed earlier than solenoid valve 22 in accordance with the height of the nozzle surface 58. Conversely, if the nozzle surface 58 is closer to the downstream tank 30 than height H, solenoid valve 22 is closed earlier than solenoid valve 32 in accordance with the height thereof. Further, if the nozzle surface 58 is exactly height H, solenoid valves 22 and 32 are closed simultaneously.

Typically, the further the nozzle surface 58 is from height H, the greater the difference between the timing at which solenoid valve 22 is closed and the timing at which solenoid valve 32 is closed becomes. FIGS. 3A to 3E show the case where the nozzle surface 58 has the former configuration.

Although any one of the above cases is dependent on the positional relationship between the nozzle surface 58, the ink level of the upstream tank 20, and the ink level of the downstream tank 30, tank volume, ink path length, ink specific gravity, and the like, control in units of about 100 ms is sufficient. As a result of this, in the nozzles of the ink-jet head 50, the positive pressure resulting from the head-of-ink difference between the ink level of the upstream tank 20 and the nozzle surface exceeds the negative pressure resulting from the head-of-ink difference between the ink level of the downstream tank 30 and the nozzle surface, and hence a slight positive pressure is produced.

Next, as shown in FIG. 2C, the sweep member 66 is moved (see period D of FIG. 3A), whereby the remaining ink drops 74 present on the nozzle surface 58 are swept away, and menisci are formed. At this time, although each meniscus minutely protrudes from the nozzle because of the slight positive pressure, the protrusion is to such a degree that the meniscus is not broken, and hence ink never escapes from the nozzle.

After this, when the sweep member 66 moves past the nozzle surface 58, solenoid valve 32 is opened to terminate the maintenance operation, and a standby state is set (see period A′ of FIG. 3A).

Finally, the maintenance unit 60 is moved to the predetermined retraction position, the sweep member 66 is returned to the initial position, and the medium conveyance section 56 is returned to the predetermined printing position, whereby the maintenance operation is terminated.

It should be noted that in the first embodiment, the downstream tank 30 is not necessarily opened to the atmosphere during period C. For example, in a system in which a valve is present in the path between the ink-jet head 50 and the downstream tank 30, control in which the valve is closed may be carried out from the beginning of period B to period A′, and solenoid valve 22, pressure pump 42, sweep member 66, and the like may be controlled in the same manner as described previously. In this case, the slight positive pressure produced during period C is determined only by the height difference between the nozzle surface 58 and the upstream tank 20.

As described above, according to the method used in this embodiment in which the slight positive pressure is produced once the ink system has been returned to atmospheric pressure following the purge operation, the pressure fluctuation per unit time at the time of producing slight positive pressure is less than that of the method in which the slight positive pressure is produced in the process of returning the ink system to atmospheric pressure immediately after the purge operation. Accordingly, it is possible to make the instrumental error in slight positive pressure small. As a result of this, it is possible to realize an ink-jet printer in which ink rarely escapes from the nozzle at the time of a wiping operation, and foreign matter rarely enters the nozzle.

Furthermore, in this first embodiment, it is possible to produce the slight positive pressure merely by controlling the ink tanks and solenoid valves used in the ink circulation without the need for adding any members.

### MODIFICATION EXAMPLE

Next, a modification example of the first embodiment of the present invention will be described below.

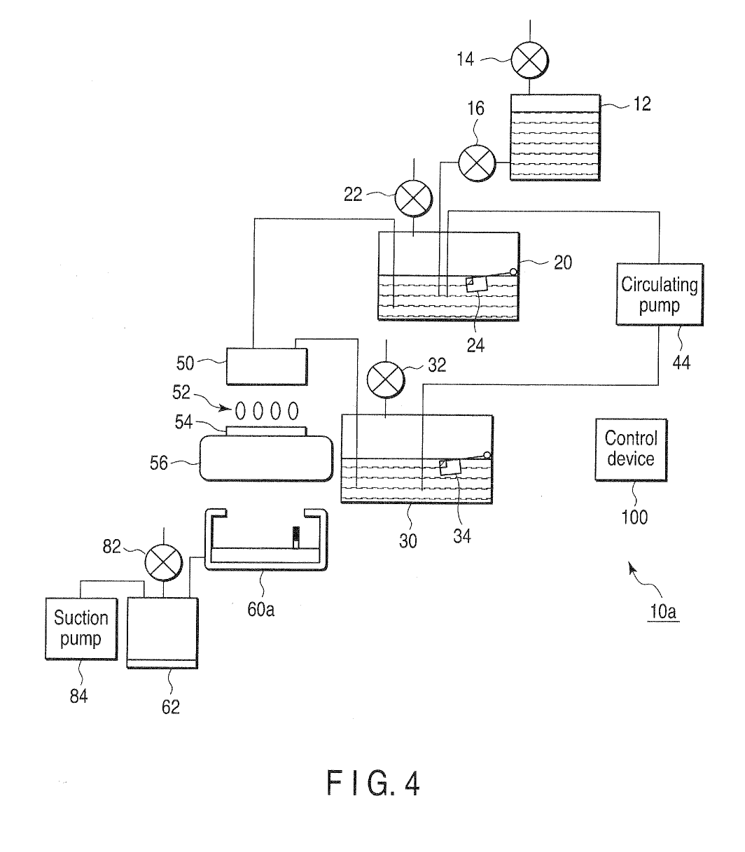

FIG. 4 is a block diagram showing the configuration of an ink-jet printer 10 which is an image formation apparatus according to a modification example of the first embodiment of the present invention.

It should be noted that in this modification example, a description of parts identical with those of the first embodiment described above will be omitted, and mainly points different from the first embodiment will be described.

In this modification example, as the purge means, a suction pump 84 attached to a waste ink tank 62 is used in place of the pressure pump 42. Further, a solenoid valve 82 for controlling the state of the waste ink tank 62 where the tank 62 is opened to the atmosphere is attached to the tank 62.

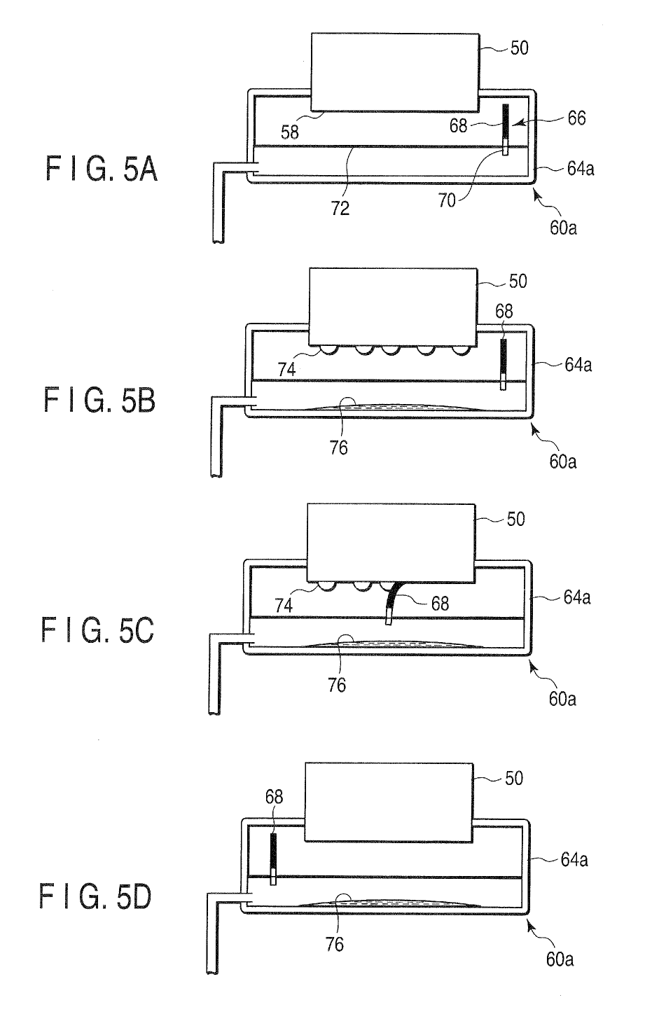

Further, as shown in FIGS. 5A to 5D, an ink pan 64a has an opening shape that can be brought into close contact with an ink-jet head 50.

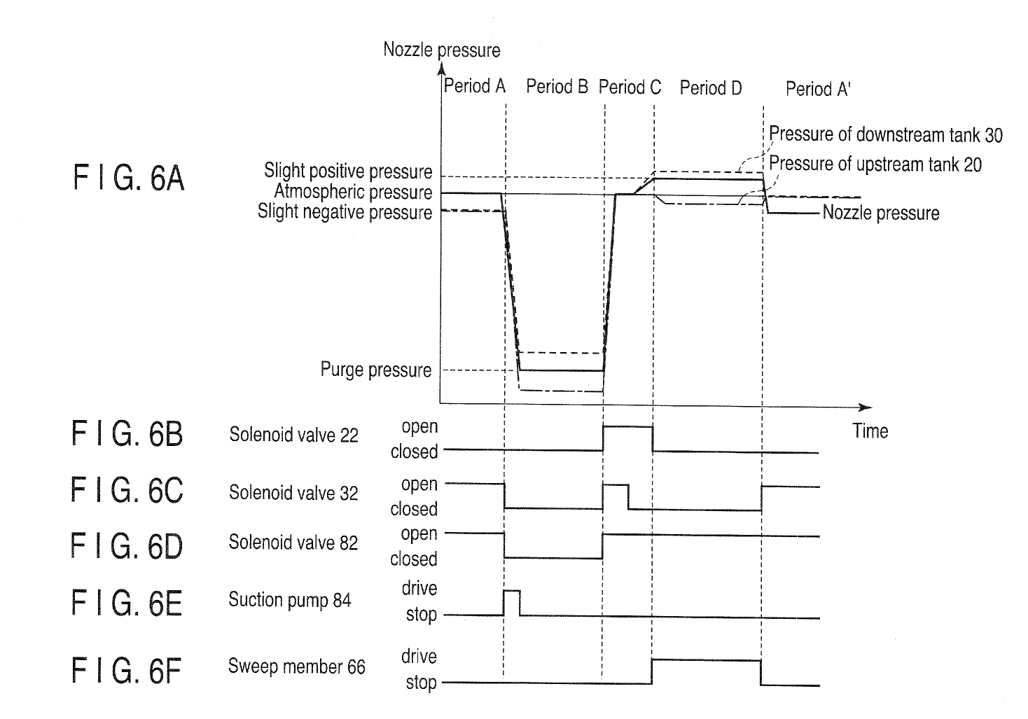

The suction pump 84 produces negative pressure in the waste ink tank 62, whereby the ink pan 64a subjects the ink-jet head 50 to a purge operation. The operation of each part in the purge operation is as shown in each of the timing charts of FIGS. 6A to 6F. FIG. 6A is a timing chart for explaining variation with time of gage pressure of a nozzle of the ink-jet head 50 during the maintenance operation, and FIGS. 6B to 6F are timing charts for explaining operation of each of a solenoid valve 22, a solenoid valve 32, a solenoid valve 82, a suction pump 84, and a sweep member 66, all of which are associated with the maintenance operation.

That is, when the maintenance operation is started (see period A of FIG. 6A), a circulating pump 44 is stopped, and a medium conveyance section 56 is moved from a printing position to a predetermined retraction position. Then, a maintenance unit 60 is moved to a position opposed to a nozzle surface 58, and the positional relationship shown in FIG. 5A is obtained.

Next, a purge operation is carried out (see period B of FIG. 6A). In the purge operation, first, solenoid valves 22, 32, and 82 are closed, and then the waste ink tank 62 is decompressed by the suction pump 84. At this time, the gage pressure of the ink pan 64a is, for example, −20 kPa. Accordingly, as shown in FIG. 5B, ink is discharged from the nozzles to drop (ink 76) onto the ink pan 64a, and some of the ink remains on the nozzle surface 58 as drops (ink drops 74).

Further, after a predetermined time has elapsed (see period C of FIG. 6A), solenoid valves 22, 32, and 82 are opened, and the upstream tank 20, downstream tank 30, and waste ink tank 62 are returned to atmospheric pressure. After this, solenoid valves 22 and 32 are closed again with a predetermined timing difference. Then, in the nozzles of the ink-jet head 50, the positive pressure resulting from the upstream tank 20 exceeds the negative pressure resulting from the downstream tank 30, and hence slight positive pressure is produced.

Next, as shown in FIG. 5C, the sweep member 66 is moved (see period D of FIG. 6A), whereby the remaining ink drops 74 present on the nozzle surface 58 are swept away, and menisci are formed.

Further, when the sweep member 66 moves past the nozzle surface 58 (see period A′ of FIG. 6A), solenoid valve 32 is opened to terminate the maintenance operation, and a standby state is set.

Finally, the maintenance unit 60 is moved to the predetermined retraction position, the sweep member 66 is returned to the initial position, and the medium conveyance section 56 is returned to the predetermined printing position. As a result of this, the maintenance operation is terminated.

It should be noted that in this modification example, the downstream tank 30 is not necessarily opened to the atmosphere during period C described previously. For example, in a system in which a valve is present in the path between the ink-jet head 50 and the downstream tank 30, control in which the valve is closed may be carried out from the beginning of period B to period A′, and the pressure pump 42, sweep member 66, and the like may be controlled in the same manner as described previously. In this case, the negative pressure resulting from the height difference between the ink-jet head 50 and the ink level of the downstream tank 30 is not produced, which is hence suitable for a case where height H is great.

As described above, according to this modification example, the modification example can also be applied to a maintenance system in which a suction purge is carried out.

### Second Embodiment

Next, a second embodiment of the present invention will be described below.

In each of the first embodiment, and the modification example thereof, an ink-jet printer of a type in which ink is circulated at the time of image formation has been described. This second embodiment is an example of an ink-jet printer of a type in which ink circulation is not carried out at the time of image formation.

It should be noted that in the second embodiment, parts of the second embodiment identical with those of the first embodiment shown in FIGS. 1 to 5, and 6A to 6F are denoted by the reference numerals identical with the first embodiment, a description of them will be omitted, and the configurations and operations of parts different from the first embodiment will mainly be described.

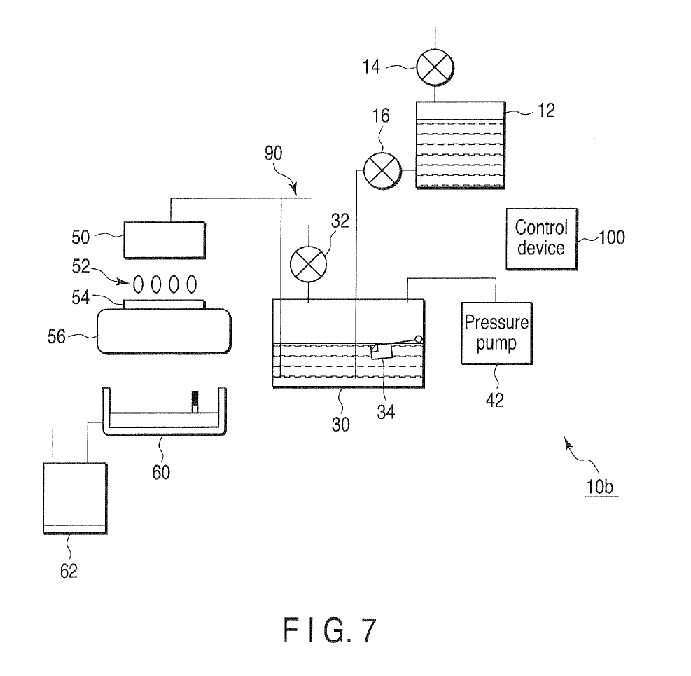

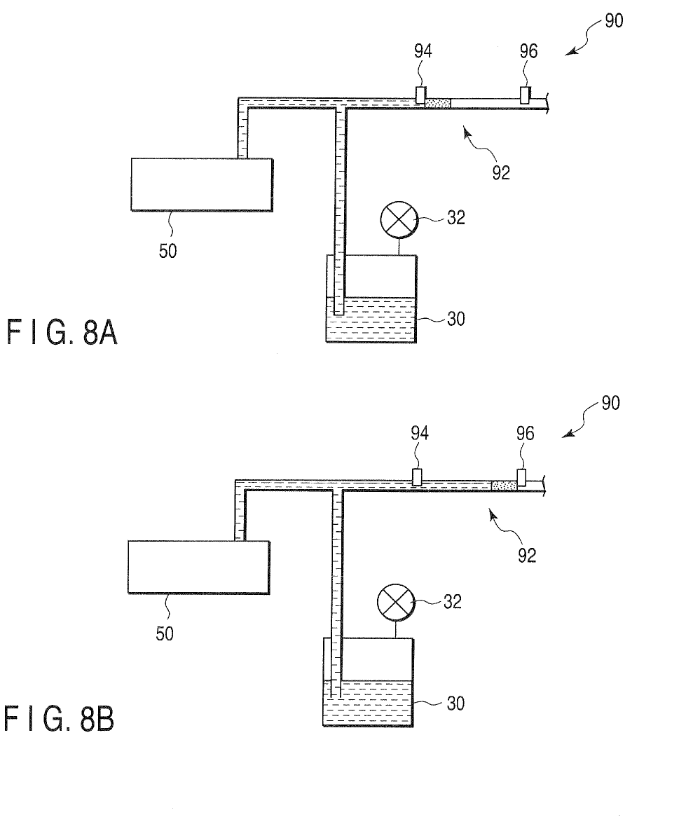

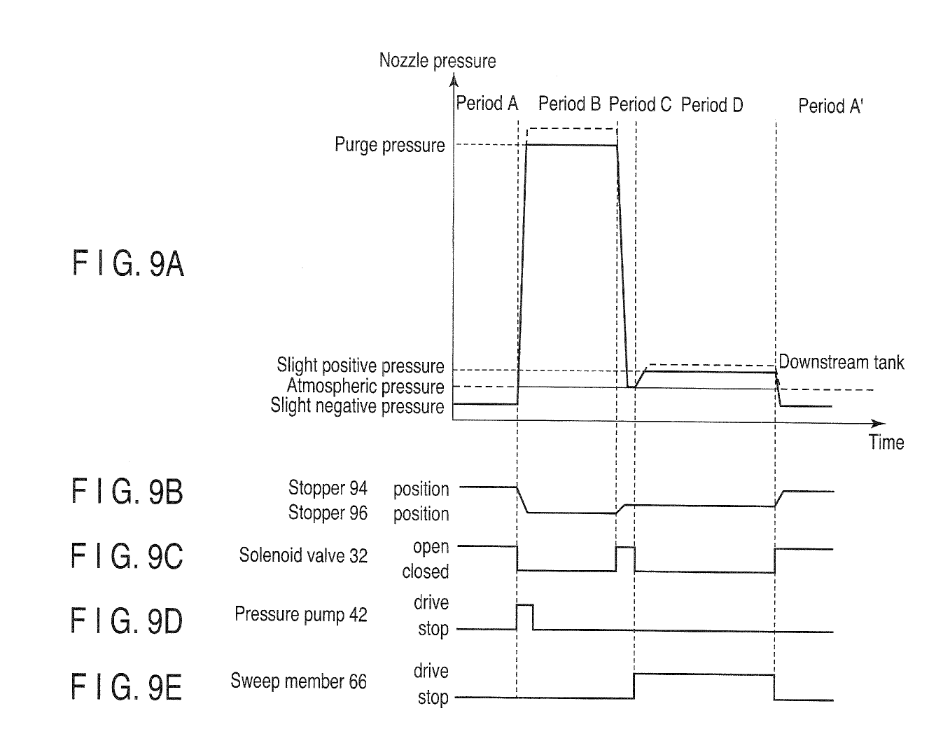

FIG. 7 is a block diagram showing the configuration of an ink-jet printer 10b which is an image formation apparatus according to the second embodiment of the present invention. Further, FIGS. 8A and 8B are views for explaining the maintenance operation. FIG. 9A is a timing chart for explaining variation with time of gage pressure of a nozzle of an ink-jet head 50 during the maintenance operation, and FIGS. 9B to 9E are timing charts for explaining a stopper position of a piston 92, and the operation of each of a solenoid valve 32, a pressure pump 42, and a sweep member 66, all of which are associated with the maintenance operation.

In the second embodiment, the upstream tank 20 is omitted, and a main ink tank 12 is connected to a downstream tank 30. In the path connecting the downstream tank 30 and ink-jet head 50 to each other, a branch section 90 serving as the slight positive pressure production means extends horizontally at a position higher than the nozzle surface 58 by a predetermined amount.

A piston 92 is inserted in the branch section 90. Pin-like stoppers 94 and 96 are inserted in the branch section to a position in the vicinity of the center of the ink path to interpose the piston 92 between them in the radial direction. The part on the stopper 94 side of the piston 92 communicates with the ink path, and the part on the stopper 96 side of the piston 92 is opened to the atmosphere. The piston 92 can operate smoothly, and when, for example, solenoid valve 32 is opened, the piston 92 moves quickly until it comes into contact with stopper 94 as shown in FIG. 8A.

Alternatively, when the downstream tank 30 is pressurized to exceed the head-of-ink pressure produced by the height difference between the ink level of the downstream tank 30 and the piston 92, the piston 92 moves quickly from the position of stopper 94 to the position of stopper 96 within, for example, about one to ten second.

It should be noted that it is assumed that a distance that does not hinder the movement of the piston to be described later is secured from the position of stopper 94 to the position of stopper 96. It is desirable that the piston 92 be made of a light material, i.e., a resin such as polyethylene, polypropylene, acryl, and the like, and a metal such as aluminum and the like are suitable. Furthermore, a hollow structure is further desirable.

Next, details of the maintenance operation in the second embodiment will be described below with reference to FIGS. 9A to 9E.

When the maintenance operation is started (see period A of FIG. 9A), the medium conveyance section 56 is moved from a printing position to a predetermined retraction position, the maintenance unit 60 is moved to a position opposed to the nozzle surface 58, and a positional relationship shown in FIG. 2A is obtained.

Next, a purge operation is carried out (see period B of FIG. 9A). In the purge operation, first, solenoid valve 32 is closed, and then the downstream tank 30 is pressurized by the pressure pump 42. At this time, the gage pressure of the ink-jet head 50 is, for example, 20 kPa. Accordingly, as shown in FIG. 2B, ink is discharged from the nozzles to drop onto the ink pan 64 (ink 76), and some of the ink remains on the nozzle surface 58 as drops. At this time, the piston 92 moves to the position of stopper 96.

Further, after a predetermined time has elapsed (see period C of FIG. 9A), solenoid valve 32 is opened, the downstream tank 30 is returned to atmospheric pressure, and thereafter solenoid valve 32 is closed. After this, atmospheric pressure acts from outside the piston 92 to move slowly the piston 92 toward stopper 94, and the nozzle pressure becomes slightly positive. At this time, the branch section 90 is horizontal, and hence even when the piston 92 is moved, the magnitude of the slight positive pressure produced remains constant.

Next, as shown in FIG. 2C, the sweep member 66 is moved (see period D of FIG. 9A), whereby the remaining ink drops present on the nozzle surface 58 are swept away, and menisci are formed. At this time, although each meniscus protrudes slightly from the nozzle because of the slight positive pressure, the protrusion is to such a degree that the meniscus is not broken, and hence ink never escapes from the nozzle.

Further, when the sweep member 66 moves past the nozzle surface 58 (see period A′ of FIG. 9A), solenoid valve 32 is opened to terminate the maintenance operation. Then, the piston 92 is moved to the position of stopper 94, and a standby state is set.

Finally, the maintenance unit 60 is moved to the predetermined retraction position, the sweep member 66 is returned to the initial position, and the medium conveyance section 56 is returned to the predetermined printing position, whereby the maintenance operation is terminated.

It should be noted that in this embodiment, the downstream tank 30 is not necessarily opened to the atmosphere during period C described previously. For example, in a system in which a valve is present in the path between the ink-jet head 50 and the downstream tank 30 at a position closer to the downstream tank 30 than the branch section 90, control in which the valve is closed is carried out from the completion of the rise in pressure during period B to period A′. Further, the pressure pump 42, sweep member 66, and the like may be controlled in the same manner as described previously, and the downstream tank 30 may be controlled to be opened to the atmosphere at an arbitrary timing during the period up to period A′. At this time, the ink inside the branch section 90 never falls into the downstream tank 30, and hence the part between the stoppers 94 and 96 can be made short. Accordingly, the overall branch section 90 can be made short.

As described above, according to the second embodiment, it is possible to easily produce stable slight positive pressure without the need for complicated control.

The present invention is not limited to the embodiments described above, and it goes without saying that the present invention can be variously modified to be implemented within a scope not deviating from the essence of the invention.

Furthermore, inventions of various stages are included in the embodiments described above, and various inventions can be realized by appropriately combining a plurality of disclosed configurational elements. For example, even when some configuration elements are eliminated from the entire configuration elements, if the problem described in the paragraph “Problem to Be Solved” can be solved and the advantage described in the paragraph “Advantage of the Invention” can be obtained, the configuration obtained after elimination of configurational elements can be realized as an invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An ink-jet printer comprising:
an ink-jet head including a plurality of nozzles for ejecting ink;
a first ink path which is connected to the ink-jet head so that ink can be guided to the ink-jet head, the ink level of which is set higher than the nozzles of the ink-jet head;
a second ink path which is connected to the ink-jet head so that ink can be guided to the ink-jet head, the ink level of which is set lower than the nozzles of the ink-jet head;
a pump for applying strong positive pressure or strong negative pressure to ink inside the ink-jet head;
a wiper for wiping a nozzle surface of the ink-jet head; and
a control section, wherein
the control section carries out
purge processing for applying strong positive pressure or strong negative pressure to ink inside the ink-jet head to forcibly eject the ink from the nozzles by driving the pump,
atmospheric pressure establishment processing for returning the strong positive pressure or strong negative pressure that has been applied to the ink inside the ink-jet head concomitantly with the purge processing to atmospheric pressure,
slight positive pressure establishment processing for applying slight positive pressure based on head-of-ink differences between the height of the nozzles of the ink-jet head subjected to atmospheric pressure, and ink levels of the first and second ink paths to the ink inside the ink-jet head, and
wiping processing for wiping the nozzle surface by means of the wiper in a state where the slight positive pressure is applied to the ink inside the ink-jet head.

2. The ink-jet printer according to claim 1, wherein
the first ink path is constituted of
a first ink tank which is arranged at a position higher than the nozzle position of the ink-jet head, and in which ink is stored, and
a first tube for connecting the ink-jet head and first ink tank to each other, through which ink is guided, and
the second ink path is constituted of
a second ink tank which is arranged at a position lower than the nozzle position of the ink-jet head, and in which ink is stored, and
a second tube for connecting the ink-jet head and second ink tank to each other, through which ink is guided.

3. The ink-jet printer according to claim 2, wherein
the first ink path includes
a first opening for connecting the inside of the first ink tank to the outside air, and
a first valve for opening and closing the first opening,
the second ink path includes
a second opening for connecting the inside of the second ink tank to the outside air, and
a second valve for opening and closing the second opening, and
the control section controls opening and closing of the first valve and second valve in such a manner that
the first valve and second valve are closed at the time of the purge processing,
at least the first valve is opened at the time of the atmospheric pressure establishment processing, and
the first valve is closed at the time of the slight positive pressure establishment processing.

4. The ink-jet printer according to claim 2, wherein
the first ink path includes
a first opening for connecting the inside of the first ink tank to the outside air, and
a first valve for opening and closing the first opening,
the second ink path includes
a second opening for connecting the inside of the second ink tank to the outside air, and
a second valve for opening and closing the second opening, and
when the negative pressure based on the head-of-ink difference between the nozzle height of the ink-jet head and the ink level of the second ink path is greater than the positive pressure based on the head-of-ink difference between the nozzle height of the ink-jet head and the ink level of the first ink path,
the control section controls opening and closing of the first valve and second valve in such a manner that
the first valve and second valve are closed at the time of the purge processing,
the first valve and second valve are opened at the time of the atmospheric pressure establishment processing, and
the second valve is closed first, and the first valve is closed after a predetermined time has elapsed following the closing of the second valve at the time of the slight positive pressure establishment processing.

5. The ink-jet printer according to claim 2, wherein
the first ink path includes
a first opening for connecting the inside of the first ink tank to the outside air, and
a first valve for opening and closing the first opening,
the second ink path includes
a second opening for connecting the inside of the second ink tank to the outside air, and
a second valve for opening and closing the second opening, and
when the first valve and second valve are opened, if pressure applied to the ink inside the ink-jet head is less than a desired slight positive pressure,
the control section controls opening and closing of the first valve and second valve in such a manner that
the first valve and second valve are closed at the time of the purge processing,
the first valve and second valve are opened at the time of the atmospheric pressure establishment processing, and
the second valve is closed first, and the first valve is closed after a predetermined time has elapsed following the closing of the second valve at the time of the slight positive pressure establishment processing.

6. The ink-jet printer according to claim 2, wherein
the first ink path includes
a first opening for connecting the inside of the first ink tank to the outside air, and
a first valve for opening and closing the first opening,
the second ink path includes
a second opening for connecting the inside of the second ink tank to the outside air, and
a second valve for opening and closing the second opening, and
when the positive pressure based on the head-of-ink difference between the nozzle height of the ink-jet head and the ink level of the first ink path is greater than the negative pressure based on the head-of-ink difference between the nozzle height of the ink-jet head and the ink level of the second ink path,
the control section controls opening and closing of the first valve and second valve in such a manner that
the first valve and second valve are closed at the time of the purge processing,
the first valve and second valve are opened at the time of the atmospheric pressure establishment processing, and
the first valve is closed first, and the second valve is closed after a predetermined time has elapsed following the closing of the first valve at the time of the slight positive pressure establishment processing.

7. The ink-jet printer according to claim 2, wherein
the first ink path includes
a first opening for connecting the inside of the first ink tank to the outside air, and
a first valve for opening and closing the first opening,
the second ink path includes
a second opening for connecting the inside of the second ink tank to the outside air, and
a second valve for opening and closing the second opening, and
when the first valve and second valve are opened, if a pressure applied to the ink inside the ink-jet head is greater than a desired slight positive pressure value,
the control section controls opening and closing of the first valve and second valve in such a manner that
the first valve and second valve are closed at the time of the purge processing,
the first valve and second valve are opened at the time of the atmospheric pressure establishment processing, and
the first valve is closed first, and the second valve is closed after a predetermined time has elapsed following the closing of the first valve at the time of the slight positive pressure establishment processing.

8. The ink-jet printer according to claim 2, wherein
the first ink path includes
a first opening for connecting the inside of the first ink tank to the outside air, and
a first valve for opening and closing the first opening,
the second ink path includes
a third valve provided in the second tube, for allowing ink to flow or intercepting the flow of ink, and
the control section controls opening and closing of the first valve and third valve in such a manner that
the first valve and third valve are closed at the time of the purge processing,
the first valve is opened while the third valve is kept closed at the time of the atmospheric pressure establishment processing, and
the first valve is closed while the third valve is kept closed at the time of the slight positive pressure establishment processing.

9. The ink-jet printer according to claim 1, wherein
the first ink path includes
a third tube an end of which is connected to the ink-jet head,
an opening formed at the other end (an end on the opposite side of the one end connected to the ink-jet head) of the third tube,
a piston which is moved inside the third tube so that the movement thereof can be linked to the movement of the ink level, and
stoppers for limiting the moving range of the piston,
the second ink path includes
a second ink tank arranged at a position lower than the nozzle position of the ink-jet head, in which ink is stored,
a second tube one end of which is connected to the third tube, the other end of which is connected to the second ink tank,
a second opening for connecting the inside of the second ink tank to the outside air, and
a second valve for opening and closing the second opening, and
the control section
closes the second valve at the time of the purge processing,
opens the second valve at the time of the atmospheric pressure establishment processing, and
closes the second valve at the time of the slight positive pressure establishment processing.

10. The ink-jet printer according to claim 9, wherein
the third tube is arranged in such a manner that the moving range of the piston limited by the stoppers extends horizontally.

11. The ink-jet printer according to claim 3, wherein
the control section is adjust a length of the predetermined time.

12. A maintenance method of an ink-jet head of an ink-jet printer including an ink-jet head including a plurality of nozzles for ejecting ink, a first ink path which is connected to the ink-jet head so that ink can be guided to the ink-jet head, the ink level of which is set higher than the nozzles of the ink-jet head, a second ink path which is connected to the ink-jet head so that ink can be guided to the ink-jet head, the ink level of which is set lower than the nozzles of the ink-jet head, a pump for applying strong positive pressure or strong negative pressure to ink inside the ink-jet head, a wiper for wiping a nozzle surface of the ink-jet head, and a control section, comprising:
a purge step of driving the pump, thereby applying strong positive pressure or strong negative pressure to ink inside the ink-jet head to forcibly eject the ink from the nozzles;
an atmospheric pressure establishment step of returning the strong positive pressure or strong negative pressure to atmospheric pressure after the purge step;
a slight positive pressure establishment step of applying slight positive pressure produced by a head-of-ink difference between the height of the nozzles of the ink-jet head and the ink level of the first ink path, and a head-of-ink difference between the height of the nozzles of the ink-jet head and the ink level of the second ink path to the ink inside the ink-jet head; and
a wiping step of wiping the nozzle surface by means of the wiper in a state where the slight positive pressure is applied to the ink inside the ink-jet head.

13. The maintenance method of an ink-jet head of an ink-jet printer according to claim 12, wherein
the first ink path includes
a first ink tank which is arranged at a position higher than the nozzle position of the ink-jet head, and in which ink is stored,
a first tube for connecting the ink-jet head and first ink tank to each other, through which ink is guided,
a first opening for connecting the inside of the first ink tank to the outside air, and
a first valve for opening and closing the first opening,
the second ink path includes
a second ink tank which is arranged at a position lower than the nozzle position of the ink-jet head, and in which ink is stored,
a second tube for connecting the ink-jet head and second ink tank to each other, through which ink is guided,
a second opening for connecting the inside of the second ink tank to the outside air, and
a second valve for opening and closing the second opening,
the first valve and second valve are closed in the purge step,
at least the first valve is opened in the atmospheric pressure establishment step, and
the first valve and second valve are closed in the slight positive pressure establishment step.

14. The maintenance method of an ink-jet head of an ink-jet printer according to claim 12, wherein
the first ink path includes
a first ink tank which is arranged at a position higher than the nozzle position of the ink-jet head, and in which ink is stored,
a first tube for connecting the ink-jet head and first ink tank to each other, through which ink is guided,
a first opening for connecting the inside of the first ink tank to the outside air, and
a first valve for opening and closing the first opening,
the second ink path includes
a second ink tank which is arranged at a position lower than the nozzle position of the ink-jet head, and in which ink is stored,
a second tube for connecting the ink-jet head and second ink tank to each other, through which ink is guided,
a second opening for connecting the inside of the second ink tank to the outside air, and
a second valve for opening and closing the second opening, and
when the negative pressure based on the head-of-ink difference between the nozzle height of the ink-jet head and the ink level of the second ink path is greater than the positive pressure based on the head-of-ink difference between the nozzle height of the ink-jet head and the ink level of the first ink path,
the first valve and second valve are closed in the purge step,
the first valve and second valve are opened in the atmospheric pressure establishment step, and
the second valve is closed first, and the first valve is closed after a predetermined time has elapsed following the closing of the second valve in the slight positive pressure establishment step.

15. The maintenance method of an ink-jet head of an ink-jet printer according to claim 12, wherein
the first ink path includes
a first ink tank which is arranged at a position higher than the nozzle position of the ink-jet head, and in which ink is stored,
a first tube for connecting the ink-jet head and first ink tank to each other, through which ink is guided,
a first opening for connecting the inside of the first ink tank to the outside air, and
a first valve for opening and closing the first opening,
the second ink path includes
a second ink tank which is arranged at a position lower than the nozzle position of the ink-jet head, and in which ink is stored,
a second tube for connecting the ink-jet head and second ink tank to each other, through which ink is guided,
a second opening for connecting the inside of the second ink tank to the outside air, and
a second valve for opening and closing the second opening, and
when the positive pressure based on the head-of-ink difference between the nozzle height of the ink-jet head and the ink level of the first ink path is greater than the negative pressure based on the head-of-ink difference between the nozzle height of the ink-jet head and the ink level of the second ink path,
the first valve and second valve are closed in the purge step,
the first valve and second valve are opened in the atmospheric pressure establishment step, and
the first valve is closed first, and the second valve is closed after a predetermined time has elapsed following the closing of the first valve in the slight positive pressure establishment step.

16. The maintenance method of an ink-jet head of an ink-jet printer according to claim 12, wherein
the first ink path includes
a third tube an end of which is connected to the ink-jet head,
an opening formed at the other end (an end on the opposite side of the one end connected to the ink-jet head) of the third tube,
a piston which is moved inside the third tube so that the movement thereof can be linked to the movement of the ink level, and
stoppers for limiting the moving range of the piston,
the second ink path includes
a second ink tank arranged at a position lower than the nozzle position of the ink-jet head, in which ink is stored,
a second tube one end of which is connected to the third tube, the other end of which is connected to the second ink tank,
a second opening for connecting the inside of the second ink tank to the outside air, and
a second valve for opening and closing the second opening, and
the second valve is closed in the purge step,
the second valve is opened in the atmospheric pressure establishment step, and
the second valve is closed in the slight positive pressure establishment step.
